(19) United States
(12) Patent Application Publication
(10) Pub. No.: US 2006/0126218 A1
(43) Pub. Date: Jun. 15, 2006

(54) System and method for improving airflow in a data storage system

(76) Inventors: Xiang Chen, Singapore (SG); Gin Yong Ong, Singapore (SG); Hin Wei Wong, Singapore (SG); Sing Thai Leong, Singapore (SG); Ishak Sugeng Iskandar, Singapore (SG); Asmin Buang, Singapore (SG)

Correspondence Address: Jennifer M. Buenzow;Seagate Technology LLC, Intellectual Property Dept. - SHK2LG, 1280 Disc Drive, Shakopee, MN, 55379-1863, US

(21) Appl. No.: 11/011,907

(22) Filed: Dec. 14, 2004

(51) Int. Cl. G11B 33/14

(52) U.S. Cl. 360/97.02

(57) ABSTRACT

An enclosure system for a mechanical device having an airflow which carries particles. The enclosure system includes a body configured to contain the airflow and a generally flat surface. The flat surface includes at least one three-dimensional feature. The enclosure system also includes a generally smooth cover configured to cover at least a portion of the flat surface and the at least one three-dimensional feature to thereby isolate the feature from the airflow and thereby reduce air turbulence in the airflow and any resultant particle deposition.

### FIELD OF THE INVENTION

The present invention relates generally to the field of data storage systems. More particularly, the present invention relates to reducing airflow turbulence within a data storage system to prevent data storage system failure.

### BACKGROUND OF THE INVENTION

Disc drives are common data storage devices. A typical disc drive includes a rigid housing that encloses a variety of disc drive components. The components include one or more discs having data surfaces that are coated with a medium for storage of digital information in a plurality of circular, concentric data tracks. The discs are mounted on a spindle motor that causes the discs to spin and the data surfaces of the discs to pass under aerodynamic bearing disc head sliders. The sliders carry transducers, which write information to and read information from the data surfaces of the discs.

To increase recording density, it has become desirable to reduce the fly height over the disc. During disc drive operation, serious damage to the disc and a loss of data can result during lowered fly height if particles were to become present in the head disc interface (HDI). Tiny particles and contaminants that are released from drive components are unavoidable in the disc drive. In addition, particles can seep into the enclosure of the disc drive from the disc drive's ambient surroundings. Particles in the disc drive's enclosure that become present in the HDI can cause performance problems such as media defects, thermal asperities, stiction, or catastrophic drive failure. Further, particles in the HDI can reach the trailing edge (TE) of the slider and damage the sensitive transducer which can prevent further read/write operations.

Current data storage systems rely on a filtration system to protect the disc from these particles. Generally, the filtration system includes a breather filter which prevents particles in the ambient surroundings of the disc drive from entering the disc drive. The filtration system also includes a recirculation filter and carbon adsorber. The recirculation filter captures the particles which are circulating throughout the disc drive.

Airflow management is an important mechanism for particle control. Ideally, the airflow within the disc drive should be a laminar flow channeled towards the recirculation filter. However, turbulent flow in a disc drive is common. Particles tend to deposit on components (especially the disc surfaces) within the disc drive if the airflow is turbulent. Areas in the disc drive can create airflow turbulence. Such areas include uneven and/or sharp surfaces on the base deck and top cover of the disc drive.

Embodiments of the present invention provide solutions to these and/or other problems and offer other advantages over the prior art.

### SUMMARY OF THE INVENTION

An enclosure system for a mechanical device has an airflow which carries particles. The enclosure system includes a body configured to contain the airflow and has a generally flat surface. The flat surface includes at least one three-dimensional feature. The enclosure system also includes a generally smooth cover configured to cover at least a portion of the flat surface and the at least one three-dimensional surface to thereby isolate the feature from the airflow and thereby reduce air turbulence in the airflow and any resultant particle deposition.

Other features and benefits that characterize embodiments of the present invention will be apparent upon reading the following detailed description and review of the associated drawings.

### BRIEF DESCRIPTION OF THE DRAWINGS

FIG. 1 is a perspective view of a disc drive.

FIG. 2 is a top plan view of a prior art base deck.

FIG. 3 is a top plan view of a base deck in accordance with an embodiment of the present invention.

FIG. 4 is a sectional view taken along line 4-4 of FIG. 4.

FIG. 5 is an exploded perspective view of a disc drive in accordance with an embodiment of the present invention.

FIG. 6 is a sectional view of a portion of the disc drive in FIG. 5 in accordance with an embodiment of the present invention.

### DETAILED DESCRIPTION OF ILLUSTRATIVE EMBODIMENTS

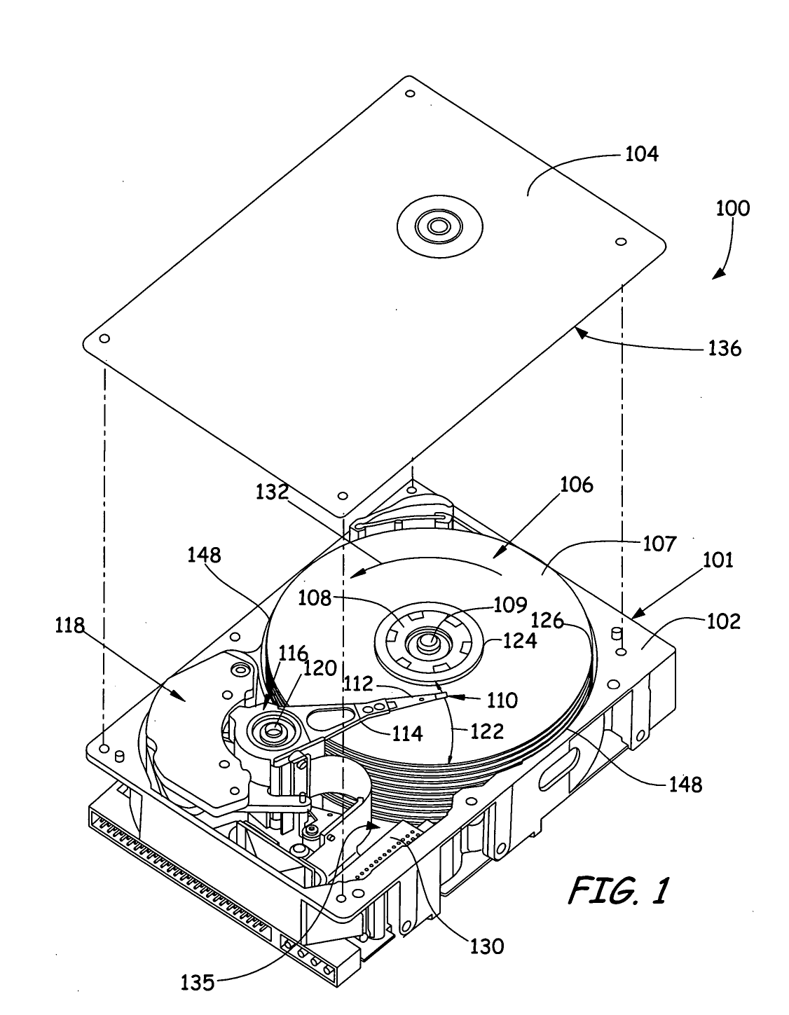

FIG. 1 is a perspective view of a disc drive 100 in which embodiments of the present invention are useful. Disc drives are common enclosure systems or data storage systems. Disc drive 100 includes a body 101 having a base deck 102 and a top cover 104. Disc drive 100 includes a plurality of generally flat surfaces. Examples include an inner bottom surface 135 of base deck 102, a top surface 136 of top cover 104 and a shroud wall 148 of base deck 102. Disc drive 100 further includes a storage media or disc pack 106, which is mounted on a spindle motor (not shown) by a disc clamp 108. Disc pack 106 includes a plurality of individual discs 107, which are mounted for co-rotation about central axis 109. Each disc surface has an associated slider 110, which carries a read/write head for communication with the surface on each disc 107.

Each slider 110 is supported by a suspension 112 which is in turn attached to a track accessing arm 114 of an actuator mechanism 116. Actuator mechanism 116 is rotated about a shaft 120 by a voice coil motor 118, which is controlled by servo control circuitry within internal circuit 130. As voice coil motor 118 rotates actuator mechanism 116, slider 110 moves in an arcuate path 122 between a disc inner diameter 124 and a disc outer diameter 126.

During operation, as discs 107 rotate in a rotational direction 132, the discs 107 drag air under the respective sliders 110 and along their air bearing surfaces. As the air passes beneath the air bearing surfaces, air compression along the airflow path causes the air pressure between the discs 107 and the air bearing surfaces to increase, which creates an aerodynamic lifting force that counteracts the load force provided by actuator mechanism 116 and causes the sliders 110 to lift and fly above, but in close proximity to the disc surfaces. While FIG. 1 illustrates one manner of actuating a data head proximate a data storage medium, the present invention, however, is applicable to data storage systems that use other techniques.

Disc drive 100 is not a closed system. An exchange of air through a breather hole (not shown) equalizes pressure differentials between the internal air of disc drive 100 and the ambient air of the surroundings. This exchange of air may result in the introduction of particles into disc drive 100. In addition, particles can originate in disc drive 100 during its manufacture as well as during operation. For example, intermittent head to disc contact can create debris. Discs 107 induce a significant airflow in disc drive 100 as discs 107 rotate in rotational direction 132. Particles within this airflow pose serious dangers to discs 107 and the heads on sliders 110, especially in high density systems in which sliders 110 fly very close to discs 107. Disc drive 100 contains a filtration system, such as a recirculation filter, to control contaminants in the airflow. Ideally, the airflow within disc drive 100 should have the capability of channeling particles towards the filtration system as much as possible.

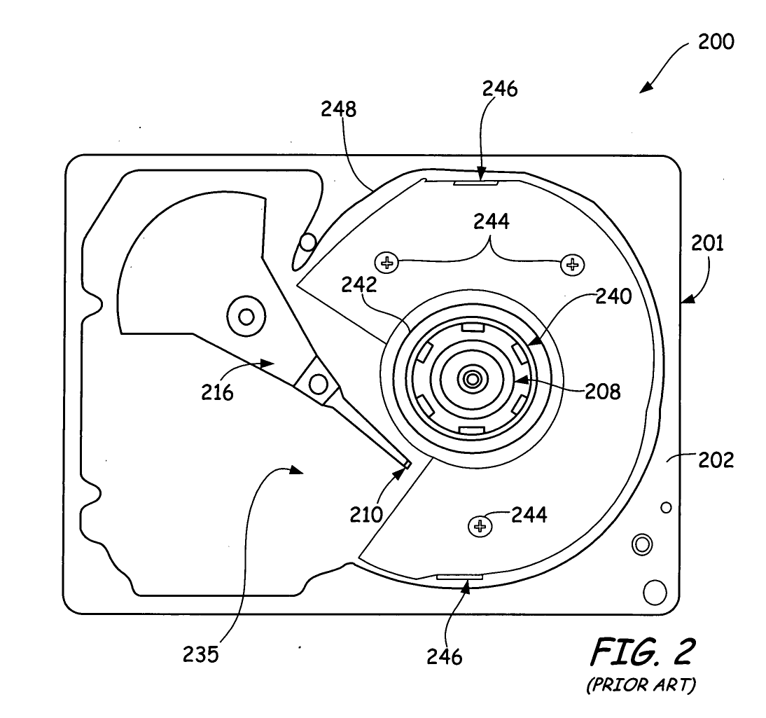

FIG. 2 is a top plan view of disc drive 200 in accordance with the prior art. FIG. 2 illustrates a body 201 having a base deck 202. Body 201 includes a spindle motor 240 mounted to the base deck 202 and surrounded by a shroud wall 248. For example, a spindle motor can be press-fit into base deck 202. In another example, a spindle motor can be secured to base deck 202 with a plurality of fasteners 244. The latter example is illustrated in FIG. 2. Body 201 also includes an actuator mechanism 216 configured to support and move sliders 210 across the surfaces of the discs (not shown in FIG. 2). Other components of base deck 202, such as the discs, have been removed such that a substantial amount of an inner bottom surface 235 is visible.

As illustrated in FIG. 2, base deck 202 includes a plurality of three-dimensional features that are exposed on inner bottom surface 235. The three-dimensional features have uneven surfaces and sharp edges. For example, the plurality of fasteners 244 protrude from inner bottom surface 235 of base deck 202. In another example, grooves 246 located along the outer edges of shroud 248 and edges 242 around spindle motor 240 are three-dimensional features that cause inner bottom surface 235 to be uneven.

After spindle motor 240 is mounted to body 201, the plurality of discs (not shown in FIG. 2) are attached with disc clamp 208. As the plurality of discs rotate, an airflow is generated. If the generated airflow is substantially laminar, particles which exist in the airflow tend to be easily channeled to a filtration system and filtered from the airflow. If, however, the generated airflow is substantially a turbulent airflow, particles tend to deposit on component surfaces such as the disc surfaces. Particles which deposit on the discs can reach the head disc interface (HDI) and cause catastrophic disc drive failure.

The plurality of three-dimensional features on inner bottom surface 235, such as fasteners 244, grooves 246 and edges 242, cause the generated airflow to change from a substantially laminar airflow to a substantially turbulent airflow. In addition, any three-dimensional features on an inner top surface of the top cover (not shown in FIG. 2), such as any surface defects or irregularities, can cause a generated airflow to change from a substantially laminar airflow to a substantially turbulent airflow. To eliminate turbulent airflow, the present invention deposits a generally smooth cover on at least one of the three-dimensional features of the disc drive. Although the above discussion generally relates to three-dimensional features on inner bottom surface 235 and the inner top surface of the top cover, it is within the scope of the present invention to utilize a generally smooth cover on any generally flat surface within the disc drive that has at least one three-dimensional feature that could cause turbulent airflow.

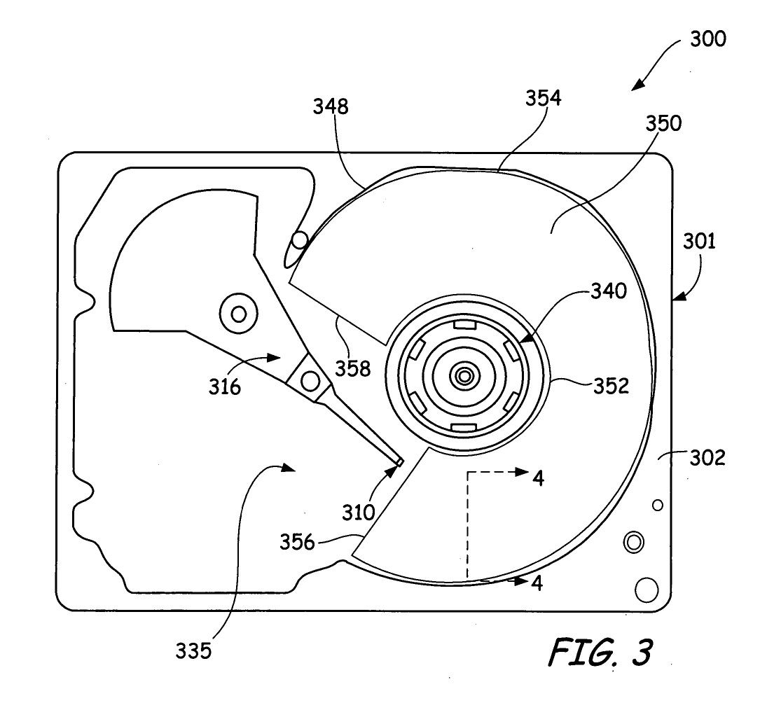

FIG. 3 is a top plane view of disc drive 300 in accordance with an embodiment of the present invention. FIG. 3 illustrates body 301 having a base deck 302. FIG. 3 also illustrates a smooth cover 350 configured to cover at least one three-dimensional feature, such as those uneven surfaces illustrated by grooves 246, fasteners 244 and edges 242 in FIG. 2.

Smooth cover 350 has a substantially circular inner circumference 352 that approaches spindle motor 340 and a substantially circular outer circumference 354 adjacent shroud wall 348. Smooth cover 350 radially extends from inner circumference 352 to outer circumference 354. Smooth cover 350 also includes leading edge 356 located downstream of sliders 310 and trailing edge 358 positioned upstream of the sliders. Smooth cover 350 angularly extends from leading edge 356 to trailing edge 358. Actuator mechanism 316 may be disposed in close relationship to leading edge 356 while allowing free movement of actuator mechanism 316. Both leading edge 356 and trailing edge 358 are bound by inner circumference 352 and outer circumference 354. Although, FIG. 3 illustrates smooth cover 350 having substantially circular inner and outer circumferences 352 and 354, it is within the scope of the present invention that smooth cover 350 can be any type of shape as long as smooth cover 350 is covering at least one three-dimensional feature on a generally flat surface. In addition, FIG. 3 illustrates smooth cover 350 covering a portion of inner bottom surface 335. It is within the scope of the present invention that smooth cover 350 can be deposited on other portions of inner bottom surface 335 and other surfaces of base deck 302 to eliminate turbulent airflow in disc drive 300. For example, smooth cover 350 can be deposited on shroud wall 348 to cover any three-dimensional features, such as surface defects or irregularities.

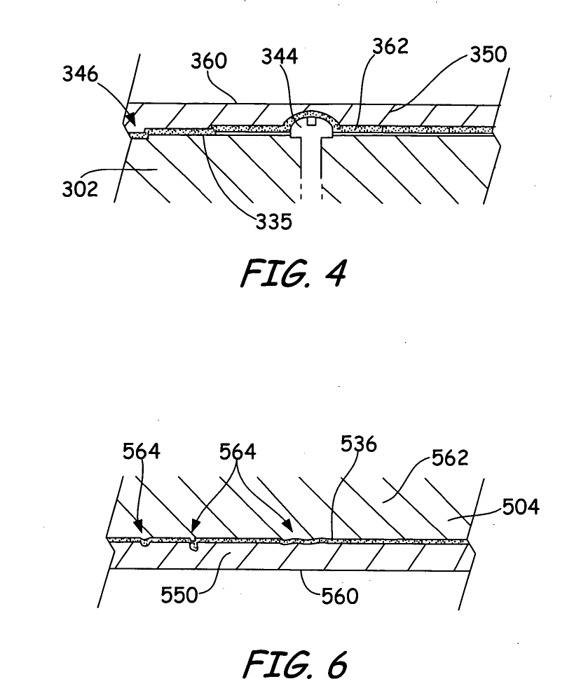

FIG. 4 illustrates a sectional view taken along line 4-4 of FIG. 3 in accordance with an embodiment of the present invention. FIG. 4 depicts and illustrates smooth cover 350 covering generally flat inner bottom surface 335 of base deck 302. As illustrated in FIG. 4, a groove 346 is a three-dimensional feature located on base deck 302. In addition, fastener 344 securely attaches a spindle motor to base deck 302 and is a three-dimensional feature. Smooth cover 350 is deposited on surface 335 and the three-dimensional features with an adhesive 362. Thus, a surface 360 of smooth cover 350 has a smooth and planar surface such that airflow turbulence is reduced.

As illustrated in FIG. 4, smooth cover 350 is an electrostatic discharge-safe (ESD-safe) material. This type of material prevents electrostatic discharge that could seriously damage the read/write head of the disc drive. For example, a flexible metallic seal tape is an ESD-safe material. The thickness of cover layer 350 should be thin enough such that the mechanics of disc drive 300 are not affected. In particular, the thickness of smooth cover 350 should be thin enough such that the smooth cover does not impede movement of the actuator mechanism 316 nor impede movement of the bottom most disc of the disc pack. For example, smooth cover 350 can have a thickness of less than 0.5 millimeters. In particular, the thickness of smooth cover 350 is 0.2 millimeters.

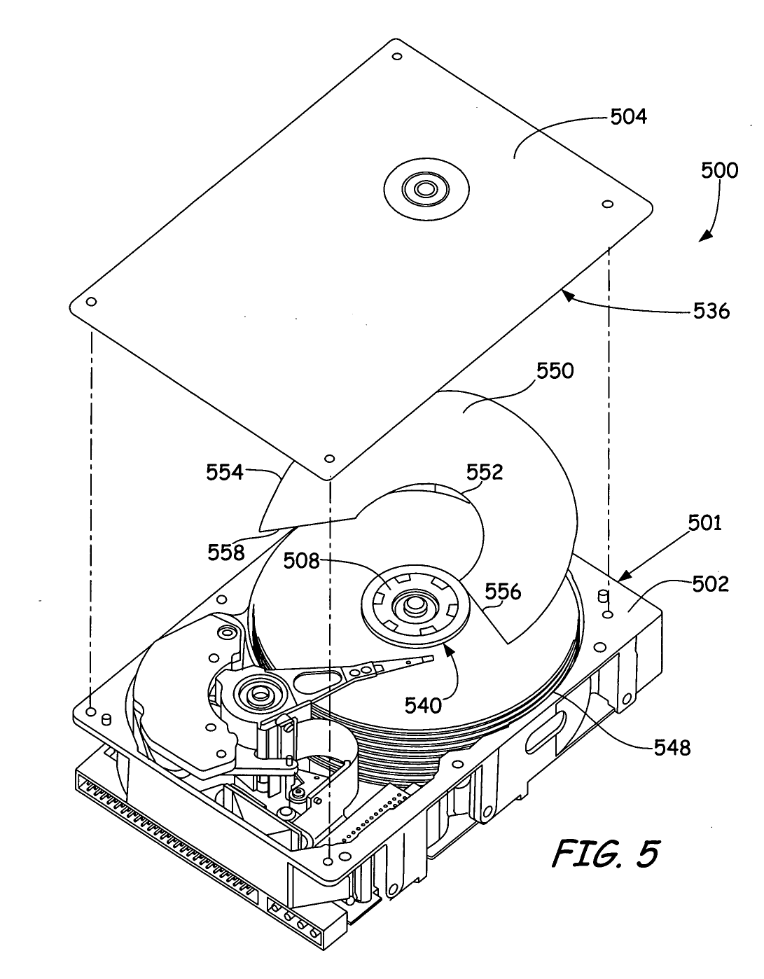

FIG. 5 illustrates a perspective view of an exploded disc drive 500 in accordance with an embodiment of the present invention. Disc drive 500 includes a body 501 having a base deck 502 and a top cover 504. FIG. 5 illustrates smooth cover 550 exploded from top cover 504 and configured to cover at least one three-dimensional feature on an inner top surface 536 of top cover 504.

Like smooth cover 350 of FIG. 3, smooth cover 550 has a substantially circular inner circumference 552 that approaches spindle motor 540 and a substantially circular outer circumference 554 adjacent shroud wall 548. Smooth cover 550 radially extends from inner circumference 552 to outer circumference 554. Smooth cover 550 also includes leading edge 556 located downstream of sliders 510 and trailing edge 558 positioned upstream of the sliders. Smooth cover 550 angularly extends from leading edge 556 to trailing edge 558. Both leading edge 556 and trailing edge 558 are bound by inner circumference 552 and outer circumference 554. Although, FIG. 5 illustrates smooth cover 550 having substantially circular inner and outer circumferences 552 and 554, it is within the scope of the present invention that smooth cover 550 can be any type of shape as long as smooth cover 550 is covering at least one three-dimensional feature. In addition, FIG. 5 illustrates smooth cover 550 covering a portion of an inner top surface 536. It is within the scope of the present invention that smooth cover 550 can be deposited on other portions of generally flat inner top surface 536 and other generally flat surfaces of base deck 502 to reduce airflow turbulence in disc drive 500.

FIG. 6 is a sectional view of smooth cover 550 adhered to and covering inner top surface 536 of top cover 504 in accordance with an embodiment of the present invention. As illustrated in FIG. 6, inner top surface 536 of top cover 504 includes a plurality of three-dimensional features, such as surface defects or irregularities 564. Smooth cover 550 is deposited on inner top surface 536 and secured with an adhesive 562. Thus, surface 560 of smooth cover 550 has a smooth and planar surface such that airflow turbulence is reduced. Like smooth cover 350 of FIG. 4, smooth cover 550 is an ESD-safe material and has a substantially similar thickness as smooth cover 350.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the enclosure system while maintaining substantially the same functionality without departing from the scope and spirit of the present invention. In addition, although the preferred embodiment described herein is directed to an enclosure system for a mechanical device, it will be appreciated by those skilled in the art that the teachings of the present invention can be applied to other enclosure systems, without departing from the scope and spirit of the present invention.

What is claimed is:

1. An enclosure system for a mechanical device having an airflow which carries particles, the enclosure system comprising:
a body configured to contain the airflow;
a generally flat surface in the body;
at least one three dimensional feature associated with the flat surface; and
a generally smooth cover configured to cover at least a portion of the flat surface and the at least one three dimensional feature to thereby isolate the feature from the airflow and thereby reduce air turbulence in the airflow and any resultant particle deposition.

2. The system of claim 1, wherein the flat surface in the body comprises an inner bottom surface of a base deck.

3. The system of claim 2, wherein the smooth cover is deposited on at least a portion of the inner bottom surface of the base deck.

4. The system of claim 1, wherein the flat surface in the body comprises an inner top surface of a top cover.

5. The system of claim 4, wherein the smooth cover is deposited on at least a portion of the inner top surface of the top cover.

6. The system of claim 1 and further comprising a rotatable storage medium mounted to the body and configured to spin in a rotational direction.

7. The system of claim 6, wherein the smooth cover is deposited proximate the rotatable storage medium.

8. The system of claim 1, wherein the generally flat surface in the body comprises a shroud wall.

9. The system of claim 8, wherein the smooth cover is deposited on at least a portion of the shroud wall.

10. The system of claim 1, wherein the smooth cover is deposited on the generally flat surface of the body with an adhesive.

11. The system of claim 1, wherein the smooth cover comprises an electrostatic discharge-safe material.

12. The system of claim 1, wherein the smooth cover comprises a flexible metallic seal tape.

13. The system of claim 1, wherein the smooth cover has a thickness comprising less than 0.5 millimeters.

14. The system of claim 13, wherein the thickness of the smooth cover comprises 0.2 millimeters.

15. The system of claim 1, wherein the mechanical device comprises a data storage system.

16. A method of reducing turbulent airflow which carries particles in an enclosed system, the method comprising:
providing a body configured to contain the turbulent airflow;
providing a generally flat surface in the body having at least one three dimensional feature; and
depositing a generally smooth cover on the at least one three dimensional feature of the flat surface.

17. The method of claim 16, wherein providing a generally flat surface in the body having at least one three dimensional feature comprises providing the generally flat surface with at least one three dimensional surface irregularity.

18. The method of claim 16, wherein depositing a generally smooth cover on the at least one three dimensional feature of the flat surface comprises securing the smooth cover to the at least one three dimensional feature of the generally flat surface with an adhesive.

19. The method of claim 16, wherein depositing a generally smooth cover on the at least one three dimensional surface of the flat surface comprises depositing an electrostatic discharge-safe material on the at least one three dimensional feature of the generally flat surface.

20. An enclosure system for a mechanical device having an airflow which carries particles, the enclosure system comprising:
a body configured to contain the airflow;
a generally flat surface in the body;
at least one three dimensional feature associated with the flat surface; and
means for covering at least a portion of the flat surface and the at least one three dimensional feature to thereby isolate the feature from the airflow and thereby reduce air turbulence in the airflow and any resultant particle deposition.
